(19) United States
(12) Patent Application Publication
(10) Pub. No.: US 2022/0403694 A1
(43) Pub. Date: Dec. 22, 2022

(54) STORAGE DEVICE FOR THEFT-PROOF STORAGE OF VALUABLE ARTICLES

(71) Applicant: Gunnebo Safe Storage Nordics AB, GÖTEBORG (SE)

(72) Inventors: Andrew Rymill, Wolverhampton (GB); Nico Kundler, Görlitz (DE)

(21) Appl. No.: 17/635,646

(22) PCT Filed: Aug. 17, 2020
(86) PCT No.: PCT/EP2020/072994

§ 371 Date: Feb. 15, 2022

(30) Foreign Application Priority Data
Aug. 16, 2019 (SE) 1950941-3

(51) Int. Cl. E05G 1/04; E05G 1/024; E05B 65/00; E05B 65/46; A47B 88/919; G07C 9/00

(52) U.S. Cl. CPC E05G 1/04; E05G 1/024; E05B 65/0075; E05B 65/46; A47B 88/919; G07C 9/00912; G07C 9/00182; E05B 47/0012

(57) ABSTRACT

This document discloses a storage device for theft-proof storage of valuable articles, comprising a cabinet, having at least one drawer space, a safe drawer, which is received in the drawer space, a safe housing, comprising side walls and a top wall connecting the side walls, wherein the safe drawer is slidably connected to the safe housing and wherein the safe housing is mounted to the cabinet in the drawer space, a locking member, which is movably connected to the safe drawer or to the safe housing, an actuator, which is operatively connected to the locking member, for controlling a movement of the locking member, and a controller, which is operatively connected to the actuator, and which is configured to control the actuator. The controller is configured for receiving a control signal, based on which the controller is configured to control the actuator. The locking member is movable between a first position, in which the locking member locks safe drawer relative to the cabinet, and a second position, wherein the safe drawer is unlocked relative to the cabinet.

### TECHNICAL FIELD

The present disclosure relates to a safe, or a strongbox, in the form of a drawer, which can be installed inside, such as integrated with, a piece of furniture, or in a cabinet.

The disclosure thus provides a device for theft-proof storage of valuable articles, such as money, car keys, jewelry, weapons and valuable documents.

The disclosure further provides a system comprising a safe and a user device configured for controlling a locking mechanism of the safe, as well as to a method of operating the safe.

### BACKGROUND

People's small valuables and car keys are at risk of being stolen, when left discarded near a front door or on a side table, with thieves taking advantage of this to break in and steal items that are visible and easily attained.

Furthermore, people often need to be able to safely store high value or personal items within their own homes, that are sometimes large and bulky.

Hence, there is a need for a safe storage for such valuable items.

While there are numerous solutions for safes that can provide sufficient protection for many situations, a problem is that such safes may be aesthetically unappealing, and, if installed inside a piece of furniture, such as a cabinet, cumbersome to access, since, e.g., two different doors may need to be opened. Moreover, the fact that existing safes use either a key, a mechanical combination lock, an electronic combination lock, or a combination thereof, makes opening the safe time consuming. The result is that, even where a safe is provided, it may not actually be used.

Hence, there is a need for a safe that can be installed in an aesthetically appealing way, that is easy to use and that provides a sufficient level of security.

### SUMMARY

An objective of the present disclosure is to provide concepts that eliminate or at least alleviate at least some of the disadvantages of prior art safes. A particular objective is to provide a safe that can be installed in an aesthetically appealing way, that is easy to use and that provides a sufficient level of security.

The invention is defined by the appended independent claims, with embodiments being set forth in the dependent claims, in the following description and in the drawings.

According to a first aspect, there is provided storage device for theft-proof storage of valuable articles, comprising a cabinet, having at least one drawer space, a safe drawer, which is received in the drawer space, a safe housing, comprising side walls and a top wall connecting the side walls, wherein the safe drawer is slidably connected to the safe housing and wherein the safe housing is mounted to the cabinet in the drawer space, a locking member, which is movably connected to the safe drawer or to the safe housing, an actuator, which is operatively connected to the locking member, for controlling a movement of the locking member, and a controller, which is operatively connected to the actuator, and which is configured to control the actuator. The controller is configured for receiving a control signal, based on which the controller is configured to control the actuator. The locking member is movable between a first position, in which the locking member locks safe drawer relative to the cabinet, and a second position, wherein the safe drawer is unlocked relative to the cabinet.

The term “cabinet” will be used to designate the structure in which the storage device is arranged, regardless of whether it is a piece of furniture or a cabinet intended for fixed installation.

The term “drawer space” is understood as a space that is adapted to receive a drawer, regardless of whether the drawer itself fills the entire space or not. Typically, the drawer space will be the space defined by a projection of the drawer front inwardly into the cabinet.

The safe housing may comprise at least side walls and a top wall. Optionally, the safe housing may comprise a bottom wall and/or a rear wall as well. Preferably, the top wall will provide a very small gap between it and a top of the safe drawer front and/or side walls. Preferably, such gap should be less than 2 mm, more preferably less than 1 mm or less than 0.5 mm.

Such a storage device can provide sufficiently theft-proof storage of valuable articles and yet be easily accessible for a user who may operate it, such as lock and unlock it, through the wireless communication device or by interaction with a biometric reader device.

The device may further comprise an anchoring device, which connects the safe housing to a fixed structure, such as a wall or a fixed cabinet.

The anchoring device may comprise at least one connector which is connectable to the fixed structure from an inside of the safe housing.

The anchoring device may be connected through a wall of the safe housing, such as a rear wall, top wall, bottom wall or a side wall of the safe housing. Alternatively, the anchoring device may be connected through an anchoring tongue forming part of the safe housing.

The anchoring device may further comprise an anchoring plate which is mountable to a wall, wherein connector is connectable to the anchoring plate.

The anchoring plate may have threads or a bayonet connector, with which a bolt provided from inside the safe drawer may connect with the anchoring plate. Alternatively, the anchoring plate may have pins extending therefrom and into the safe drawer, whereby connectors, such as bolts, may engage the pins from the inside.

The safe drawer may be received in the drawer space in a drawer space portion that is situated at least partially, preferably entirely, above side walls of a drawer, which is slidably mounted to the cabinet and received in said drawer space. Typically, the safe housing would be mounted to an inside of the cabinet and the safe drawer would be received in the safe housing.

The device may further comprise a drawer coupling, which is configured to engage the drawer when the safe drawer is unlocked relative to the cabinet, such that the safe drawer is slidable with the drawer.

The locking member may have a first portion for engaging the safe housing and a second portion for engaging the drawer.

The first and second portions of the locking member may be arranged at opposite ends of the locking member, as seen in the longitudinal direction. For example, the first portion may protrude into a locking device of the safe housing when the locking member is in the locking position, and the second portion may protrude into a recess in the drawer side wall when the locking member is in the open position.

The device may further comprise a locking arrangement, which is fixedly connected to the other one of the safe drawer and the safe housing, and which is adapted for engagement with the locking member, when the locking member is in said first position.

The locking arrangement may comprise a recess.

Such a recess may be formed in a frame or wall forming part of the cabinet and/or of the safe housing. Alternatively, or as a supplement, the recess may be formed in a side, top or bottom wall of the safe drawer.

Alternatively, or as a supplement, the locking arrangement may comprise a device which protrudes inwardly from the safe housing.

Such a protrusion may be formed in, or connected to, a side, top or bottom wall of the safe drawer, if any.

The locking member may be slidably mounted to safe drawer or to the safe housing.

Alternatively, the locking member may be rotatably mounted to safe drawer or to the safe housing.

The may further comprise a transmission mechanism, which is operable between the actuator and the locking member, for controlling a position of the locking member.

The transmission mechanism may comprise a worm gear having a worm screw connected to the actuator.

The transmission mechanism may further comprise a ratchet fixed to the locking member, and an axle, having a gear wheel engaging the ratchet and a worm wheel engaging the worm screw.

Alternatively, the transmission mechanism may comprise a slider, which is connected to an eccentric portion of said locking member.

The device may further comprise a second locking member, said second locking member being spaced from the first locking member, so as to engage an opposite portion of the cabinet.

The second locking member may be movable with the first locking mechanism, such as by being connected to the same transmission mechanism.

The safe drawer may comprise a bottom, a pair of side walls, a front wall and a rear wall.

The safe drawer side walls, or the safe housing, may present a height, which corresponds to a maximum load height of a space in which the drawer is arranged, less a gap sufficient to enable movement of the safe drawer in the drawer space.

Alternatively, the safe housing may present a height, which corresponds to a maximum load height of a space in which the drawer is arranged.

The safe drawer bottom, side walls, front wall and rear wall may be formed of sheet metal, having a thickness of at least 1.5 mm, preferably at least 2.5 mm or at least 4 mm and most preferably a thickness of 6-10 mm.

The safe drawer may further comprise an inner drawer, which is receivable in the safe drawer, a lifting mechanism, configured for raising the inner drawer relative to the safe drawer when the drawer is in an open state, and a lift actuator, which is operatively connected to the lifting mechanism, for controlling a movement of the lifting mechanism. The controller may be operatively connected to the lift actuator, and configured to control the lift actuator.

The controller may comprise a wireless communication device for receiving said signal in the form of a control signal.

Hence, the user device may be used for controlling an opening and/or closing operation of the device.

Alternatively, or as a supplement, the device may further comprise a biometric reader device and a memory for storing authorization data, and the controller may be configured to receive biometric data from the biometric reader device, to compare said biometric data with the authorization data and to receive said signal based on said comparison.

The lifting mechanism may be configured to lift the inner drawer relative to the safe drawer by a vertical distance corresponding to at least a maximum loading height of the safe drawer.

The device may further comprise a biometric reader device and a memory for storing authorization data, and the controller may be configured to receive biometric data from the biometric reader device, to compare said biometric data with the authorization data and to receive said signal based on said comparison.

Hence, the signal may be generated by the user device or by the controller, based on the biometric data.

According to a second aspect, there is provided a storage device for theft-proof storage of valuable articles, comprising a cabinet, having at least one drawer space, a safe drawer, which is received in the drawer space, a safe housing, comprising side walls and a top wall connecting the side walls. The safe drawer is slidably connected to the safe housing and the safe housing is mounted to the cabinet in the drawer space. The device further comprises an inner drawer, which is receivable in the safe drawer, a lifting mechanism, configured for raising the inner drawer relative to the safe drawer when the safe drawer is in an open state, a lift actuator, which is operatively connected to the lifting mechanism, for controlling a movement of the lifting mechanism, and a controller, which is operatively connected to the lift actuator, and configured to control the lift actuator.

Hence, a safe having an inner drawer with an actuator-driven lifting mechanism can be provided with any type of locking mechanism and locking mechanism control.

The controller may be configured for receiving a control signal, based on which the controller is configured to control the lift actuator.

The controller may comprise a wireless communication device for receiving said signal in the form of a control signal.

Hence, the user device may be used for controlling an opening and/or closing operation of the device.

Alternatively, or as a supplement, the device may further comprise a biometric reader device and a memory for storing authorization data, and the controller may be configured to receive biometric data from the biometric reader device, to compare said biometric data with the authorization data and to receive said signal based on said comparison.

The lifting mechanism may be configured to lift the inner drawer relative to the safe drawer by a vertical distance corresponding to at least a maximum loading height of the safe drawer.

According to a third aspect, there is provided a system for theft-proof storage of valuable articles, comprising at least one storage device as claimed in any one of the preceding claims, and a user device in the form of a tablet computer or a smartphone, wherein the user device is configured to communicate with the controller.

The user device may be provided with a software app to provide an interface by which the user may control the storage device.

The user device may be configured to generate or receive a signal representing a storage device ID, when the user device is in proximity of the storage device.

The user device may be configured to read an identification tag arranged on or near the cabinet.

The identification signal may be received by the user device reading a tag, such as a QR or an RFID type tag. Such tag may be arranged on the cabinet, or, in the latter case, hidden inside the cabinet. The user device may be configured to establish a short range communication link with the controller.

A short range communication link, such as Bluetooth, NFC, Wi-Fi, or the like, may be established in order to identify the storage device to the user device and/or vice versa. The communication link may also be used to exchange signals between the storage device controller and the user device, such as control signals from the user device and/or status signals from the controller.

The user device may be configured to identify a user who is authorized to operate the storage device, and to send a signal to the controller, causing the controller to unlock the safe drawer unlocked relative to the cabinet, when an authorized user is identified.

The identification may include reading of biometric information, such as facial features, fingerprint, etc; entry of a PIN code or a password; replying to one or more control questions, or the like.

The controller may be configured to send a status signal to the user device, indicating at least one of: a position of the locking member, a position of the safe drawer and a position of the lifting mechanism, if any.

According to an fourth aspect, there is provided a storage device for theft-proof storage of valuable articles, comprising a cabinet, having a first one drawer space, and a second drawer space, a drawer, which is installed in the first drawer space, such that the drawer is slidably connected to the cabinet, a safe drawer, which is received in the second drawer space, and a safe housing, comprising side walls and a top wall connecting the side walls, wherein the safe drawer is slidably connected to the safe housing and wherein the safe housing is mounted to the cabinet in the second drawer space.

The drawer may comprise a first drawer front, and a second drawer front may be mounted to the safe drawer, such that said first drawer front and said second drawer front are alignable in a common plane when the drawer and the safe drawer are in respective closed positions.

The drawer may comprise a first bearing arrangement, which is operable between the cabinet and a drawer body.

The safe drawer may comprise a second bearing arrangement, which is operable between the safe housing and the safe drawer.

The device may further comprise a locking member, which is movably connected to the safe drawer or to the safe housing, an actuator, which is operatively connected to the locking member, for controlling a movement of the locking member, and a controller, which is operatively connected to the actuator, and which is configured to control the actuator, wherein the controller is configured for receiving a control signal, based on which the controller is configured to control the actuator, and wherein the locking member is movable between a first position, in which the locking member locks safe drawer relative to the cabinet, and a second position, wherein the safe drawer is unlocked relative to the cabinet.

The device may further comprise an anchoring device, which connects the safe housing to a fixed structure, such as a wall or a fixed cabinet.

According to a fifth aspect, there is provided a method of operating a storage device as described above, comprising providing a user device in the form of a tablet or a smartphone, executing an application software in the user device to provide a storage device interface, receiving a signal in the user device indicating that the user device is in proximity of the storage device, receiving authorization information through the interface, verifying the authorization information to determine whether it represents a user who is authorized to open the storage device, establishing a communication link to the controller, and sending a signal indicating to the controller to open the storage device.

The step of receiving the signal in the user device indicating that the user device is in proximity of the storage device may comprise reading information off a tag associated with, and arranged in proximity of, the storage device.

The step of receiving the signal in the user device indicating that the user device is in proximity of the storage device may comprise establishing the communication link to the controller.

In the method, input of the authorization information into the user device may only be allowed when it is indicated that the user device is in the proximity of the storage device.

According to a sixth aspect, there is provided a storage device for theft-proof storage of valuable articles, comprising a cabinet, having at least one drawer space, a safe drawer, which is received in the drawer space, a safe housing, comprising side walls and a top wall connecting the side walls, wherein the safe drawer is slidably connected to the safe housing and wherein the safe housing is mounted to the cabinet in the drawer space, and an anchoring device, for connecting the safe housing to a fixed structure, such as a wall or a fixed cabinet.

Hence, a drawer safe may be provided having an anchoring mechanism, regardless of what mechanism is used to lock the safe drawer to the cabinet and/or safe housing.

The safe housing may further comprise a bottom wall and a rear wall.

The anchoring device may comprise at least one connector which is connectable to the fixed structure from an inside of the safe housing.

The anchoring device may further comprise an anchoring plate which is mountable to a wall, wherein connector is connectable to the anchoring plate.

According to a seventh aspect, there is provided a storage device for theft-proof storage of valuable articles, comprising a cabinet, having at least one drawer space, and a drawer received in the drawer space, a safe drawer, which is received in the drawer space, a safe housing, comprising side walls and a top wall connecting the side walls, wherein the safe drawer is slidably connected to the safe housing and wherein the safe housing is mounted to the cabinet in the drawer space, a locking member, which is movably connected to the safe drawer or to the safe housing. The safe drawer is received in the drawer space in a drawer space portion that is situated at least partially, preferably entirely, above side walls of the drawer. The device comprises a drawer coupling, which is configured to engage the drawer when the safe drawer is unlocked relative to the cabinet, such that the safe drawer is slidable with the drawer.

Hence, a drawer safe may be provided having a drawer coupling for engaging the drawer when the safe drawer is unlocked, and for disengaging the drawer when the safe drawer is locked, regardless of what locking mechanism and locking mechanism control is chosen for the drawer safe.

The locking member may have a first portion for engaging the safe housing and a second portion for engaging the drawer.

The safe drawer may be received in the drawer space in a drawer space portion that is situated at least partially, preferably entirely, above side walls of a drawer, which is slidably mounted to the cabinet and received in said drawer space.

The safe drawer may comprise a bottom, a pair of side walls, a front wall and a rear wall.

The safe drawer side walls may present a height, which corresponds to a maximum load height of a space in which the drawer is arranged, less a gap sufficient to enable movement of the safe drawer in the drawer space.

The safe drawer may further comprise an inner drawer, which is receivable in the safe drawer, a lifting mechanism, configured for raising the inner drawer relative to the safe drawer when the drawer is in an open state, and a lift actuator, which is operatively connected to the lifting mechanism, for controlling a movement of the lifting mechanism. The controller is operatively connected to the lift actuator, and configured to control the lift actuator.

The device lifting mechanism may be configured to lift the inner drawer relative to the safe drawer by a vertical distance corresponding to at least a maximum loading height of the safe drawer.

According to an eighth aspect, there is provided a storage device for theft-proof storage of valuable articles, comprising a safe housing, comprising side walls and a top wall connecting the side walls, a safe drawer, which is slidably received in the safe housing, a locking member, which is movably connected to the safe drawer, and a drawer coupling. The locking member is movable between a first position, in which the locking member locks safe drawer relative to the safe housing, and a second position, wherein the safe drawer is unlocked relative to the cabinet. The drawer coupling is movable between a first position in which the drawer coupling is received within the safe housing, and a second position, wherein the drawer coupling extends out of the safe housing.

The drawer coupling may be connected to, preferably integrated with, the locking member, such that the locking member and the drawer coupling are in their respective first positions simultaneously and in their respective second positions simultaneously.

### BRIEF DESCRIPTION OF THE DRAWINGS

FIG. 1 is a schematic perspective illustration of a safe installation in a chest of drawers.

FIG. 2 is a schematic perspective illustration of an alternative safe installation in a chest of drawers.

FIGS. 3a-3d are schematic perspective illustrations of another alternative safe installation in chest a drawer cabinet.

FIGS. 4a-4c are schematic sectional views of a locking mechanism for use in the safe installation.

FIG. 5 is a schematic diagram view of a system comprising a safe installation and a controller.

FIG. 6 is a schematic sectional view illustrating a third safe installation in a chest of drawers.

FIGS. 7a-7b schematically illustrate an alternative locking mechanism.

### DETAILED DESCRIPTION

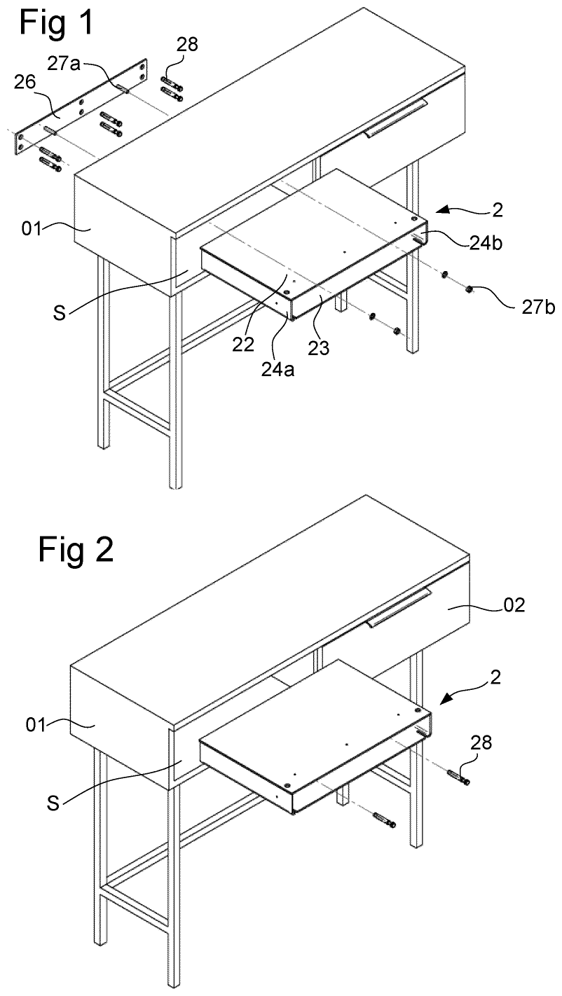

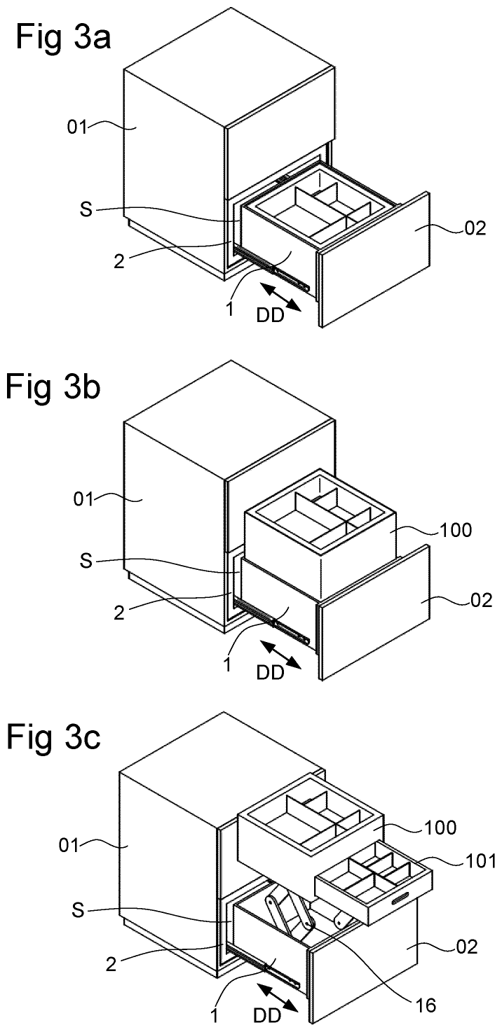

Referring to FIGS. 1 and 2, there is illustrated a part of a first installation of a drawer safe, i.e. a safe that is installed in a drawer space S of a cabinet or a piece of furniture. The installation illustrated in FIGS. 1 and 2 is in a piece of furniture, in the form of a sideboard that is intended to be positioned adjacent to, and preferably in contact with, a wall. Similar installations may be applied to other pieces of furniture having a drawer and being intended for positioning adjacent to a wall W, such as a chest of drawers, a bedside table, an escritoire or a desk.

The cabinet 01 may thus be any type of furniture or cabinet having a drawer (not shown), which is received in a drawer space S.

As illustrated in FIG. 1, a drawer safe comprises a safe housing 2, which may have a top wall 22, a bottom wall 23 and a pair of side walls 24a, 24b. The top wall 22 may connect upper portions of the side walls 24a, 24b and the bottom wall 23 may connect lower portions of the side walls 24a 24b.

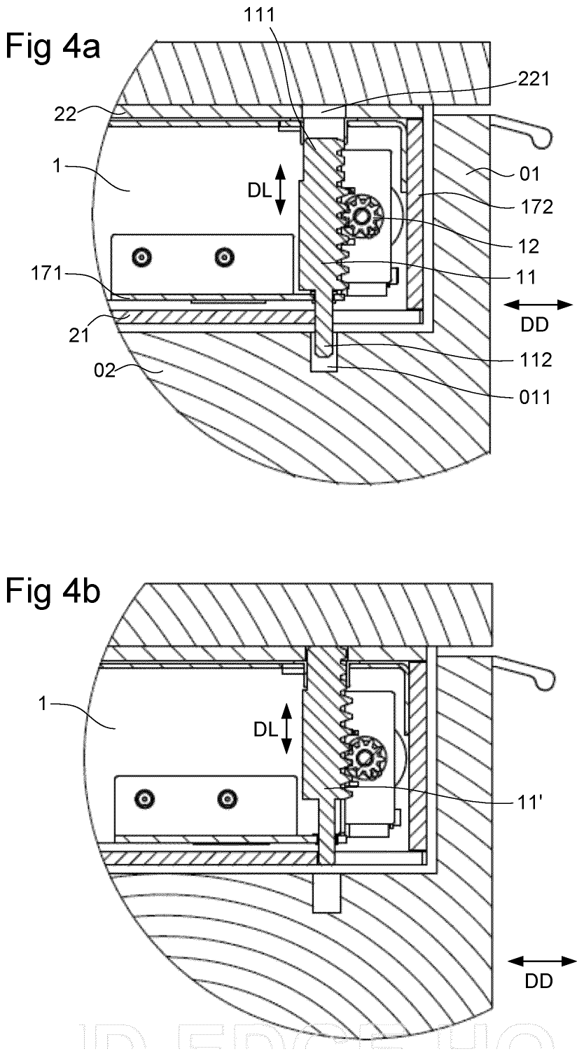

A rear wall 25 (FIG. 4c) may be provided, connecting rear portions of two or more of the top, bottom and/or side walls 22, 23, 24a, 24b. Hence, the safe housing 2 has a front opening.

The safe housing 2 may be mounted to the cabinet by fasteners, such as screws, that are operated from inside the safe housing 2.

As illustrated in FIG. 1, the safe housing may be anchored to a structure which may be fixed, or at least considerably heavier and/or bulkier than the cabinet 01 itself.

FIG. 1 illustrates that an anchoring plate 26 may be mounted to the structure, at a height and position corresponding to where the drawer safe is to be positioned. The mounting may be achieved by a plurality of bolts 28 or the like. Bolts that are suitable for mounting safes are known as such. The actual bolt/plug system will need to be chosen with regard to the nature of the structure to which the anchoring plate is to be mounted, as is well known to the skilled person.

The anchoring plate 26 may be provided with one or more protrusions, such as pins 27a, which are connected to the anchoring plate and which protrude from the anchoring plate. Preferably, the protrusions protrude normal to a plane of the anchoring plate. The rear wall of the safe housing 2 may have corresponding openings for receiving the pins 27a. Fasteners, such as nuts 27b may be applied from inside the safe housing, so as to connect the safe housing 2 to the anchoring plate 26 and thus to the structure.

FIG. 2 illustrates an alternative installation of the safe housing 2, wherein connectors 28, such as bolts, are screwed directly from inside the safe housing 2 into the structure, so as to connect the safe housing 2 to the structure.

The safe housing may take up the entire drawer space, in which case any pre-existing drawer will need to be removed. In this case, the drawer front from the pre-existing drawer may need to be attached to the safe drawer 1, so as to conceal the safe drawer.

Alternatively, as illustrated in FIGS. 1 and 2, the safe housing 2 may take up only a part of the drawer space S. For example, the safe housing 2 may take up the upper part of the drawer space S, such that the pre-existing drawer, provided its side walls are sufficiently low and its slide bearings are arranged at a lower portion of the drawer space S, may remain. In such case, the pre-existing drawer may be used as before, albeit with a reduced load height, while the drawer safe is concealed by the drawer front of the pre-existing drawer.

The safe housing 2 may be formed of sheet metal and in particular of sheet steel, such as mild steel. Preferably, such sheet will have a thickness of at least 1.5 mm, preferably at least 2.5 mm or at least 4 mm and most preferably a thickness of 6-10 mm.

In order to allow the safe housing 2 to be mounted to the wall, corresponding openings may be provided in a rear wall of the cabinet 01. Alternatively, the cabinet 01 may not have a rear wall, or it may be removed.

The safe drawer 1 may be slidably mounted in the safe housing 2 by means of a slide bearing arrangement (not shown), which provides a sliding direction DD, that may be horizontal and substantially parallel with the slide direction of any pre-existing drawer. Such slide bearing arrangements are well known to the skilled person.

The safe drawer 1 may comprise a drawer bottom 171, side walls and a front wall 172. The safe drawer 1 may also comprise a rear wall.

The slide bearing arrangement may be connected to safe drawer side walls and/or to the safe drawer bottom 171.

The safe drawer may thus provide a secured space delimited by the safe drawer bottom, the safe drawer side walls, the safe drawer front wall, the safe housing top wall and at least one of a safe drawer rear wall and a safe housing rear wall.

Preferably, safe housing side walls and a safe housing bottom may also be provided.

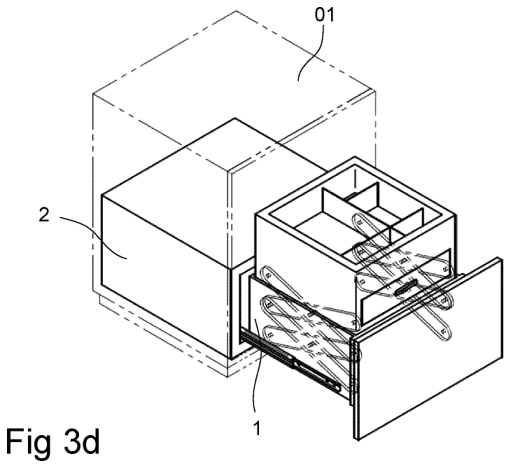

Referring to FIGS. 3a-3d, there is illustrated a second installation of a drawer safe. The installation illustrated in FIGS. 3a-3d is in a cabinet, which is intended to be fixedly installed in a building. The installation illustrated in FIGS. 3a-3d is in a cabinet that is intended for installation under a counter, such as a kitchen counter, a bathroom counter, a walk-in-closet counter or a laundry room counter. However, this installation may also be used in a chest of drawers, in a bedside table, or the like.

Anchoring of the drawer safe of FIGS. 3a-3d may be achieved in the same manner as that of FIGS. 1-2.

In FIGS. 3a-3d, there is illustrated an embodiment wherein the safe drawer 1 further comprises an inner drawer 100 and a lifting mechanism 16.

The inner drawer 100 may be shaped and sized to fit inside the safe drawer 1. The safe drawer 1 may be connected to the cabinet 01 in any manner similar to that described with reference to FIGS. 1-2. Preferably, the safe drawer 1 of FIGS. 3a-3d may be installed in a lowermost drawer forming part of a stack of drawers comprising two or more drawers. Also preferably, the safe drawer 1 of FIGS. 3a-3d may be installed so as to take up the entire drawer space S.

While the safe drawer 1 is produced of a safe material, such as sheet metal, the inner drawer 100 may be produced of a lighter material, such as a wood or polymer based material, since the inner drawer 100 will be protected by the safe drawer 1.

The lifting mechanism may be provided in the safe drawer 1 and may comprise a mechanical lifting device 16, such as a scissor lift, or the like, and an actuator 15 for controlling the movement of the mechanical lifting device 16.

Optionally, the inner drawer 100 may comprise one or more additional drawers 101, which may be manually operated.

Referring to FIG. 3d, there is illustrated the installation according to FIGS. 3a-3d. in this illustration, the lines representing the cabinet 01 have been dash-dotted, such that the safe housing 2 is visible.

Referring to FIGS. 4a-4c, the safe drawer 1 comprises a locking mechanism that enables the safe drawer 1 to be locked to the safe housing 2 and/or to the cabinet 01, such that the safe drawer 1.

The locking mechanism may comprise a locking member 11, which may have the form of a rod that is slidably mounted to the safe drawer 1. The locking member may be slidable along its longitudinal direction DL.

When the locking member 11 is in a retracted position (FIG. 4a), the safe drawer is unlocked and can be opened.

When the locking member is in an extended position (FIG. 4b) and engages, e.g. a locking device 221 in the safe housing 2 and/or in the cabinet wall. The safe drawer is locked and cannot be opened.

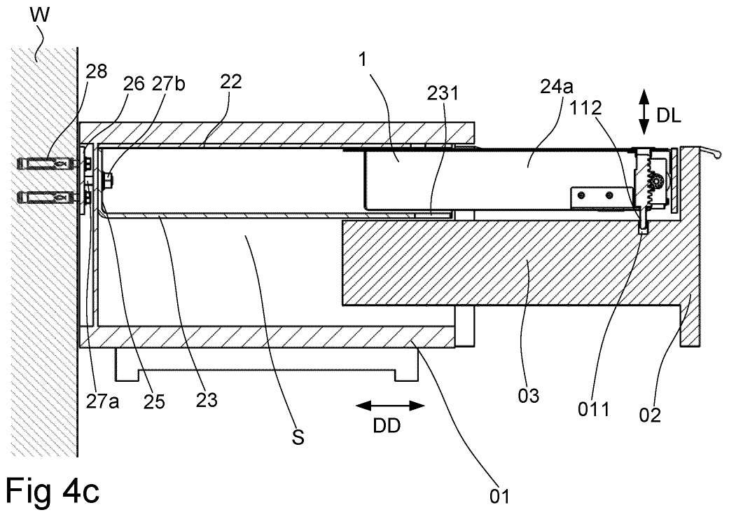

The position of the locking member 11 is controllable by means of an actuator 13 (FIG. 5), which may be directly connected to the locking member 11, or which may be connected to the locking member 11 through a transmission mechanism 12.

As an example, the transmission mechanism may comprise a worm drive, wherein a worm screw may be connected to an outgoing axle of the actuator and a worm wheel may be connected to an axle that drives the locking member 11.

A ratchet may be provided on the locking member, a gear wheel interacting with the ratchet may be connected to the axle from the worm wheel.

The actuator 13 may be any type of actuator, such as an electric motor providing a rotating motion by means of a shaft. Alternatively, a linear motor may be used.

In the embodiment disclosed with reference to FIGS. 3a-3d, the drawer, the safe housing and the anchoring mechanism may be same as that described with reference to FIGS. 1-2.

Referring to FIG. 4c, there is illustrated a sectional view of a safe installation according to one embodiment. The safe is installed in a drawer space S of a cabinet 01 that is positioned immediately adjacent, preferably in contact with, a wall W. The safe housing 2 is anchored to the wall W by means of an anchoring plate 26, which is connected to the wall W by anchoring bolts 28. An anchoring pin 27a protrudes from the anchoring plate 26 and extends through a hole in the rear wall 25 of the safe housing 2. An anchoring nut 27b is connected to a distal end of the anchoring pin 27a by means of a threaded connection.

A drawer 03 is received in the drawer space S. Drawer side walls are low enough so as to allow the safe housing 2 to be installed in the drawer space, above the drawer 03.

As can be seen, the lower portion 112 of the locking member 11a has been received in a recess 011 in the drawer 03 side wall, such that the safe drawer 1 will become locked to the drawer 03, so that it will follow the movement of the drawer 03.

On the other hand, the while the safe is locked, the drawer can be opened as a normal, non-secure, drawer while the safe remains concealed in the cabinet.

The safe housing bottom wall 23 has a cutout 231, which may be in the form of a slit to allow the lower portion 112 of the locking member to protrude into the recess 011 and to follow the drawer's 03 movement.

Hence, when the safe drawer 2 is in its locked position, the upper portion 111 of the locking member engages the recess 221 in the safe housing so as to lock the safe drawer relative to the safe housing 2, while the lower portion 112 is retracted, such that the drawer 03 is freely movable, and can be used as a standard/non-secured drawer, whereas the safe reminds hidden and non-accessible.

When the safe drawer 1 is in its unlocked position, the upper portion 111 of the locking member is retracted, so as to disengage from the recess 221 in the safe housing, while the lower portion 112 is extended and extends into the recess 011 in the drawer wall, so that the safe drawer 1 will follow the drawer 03 when the latter is opened.

Hence, when the safe is locked, the drawer 03 is freely accessible, albeit with limited load height.

When the safe is unlocked, the safe drawer follows the drawer 03, whereby the load space of the drawer 03 is not accessible.

Referring to FIG. 5, there is illustrated a system, which the drawer safe 1, 2 may form part of. In addition to the safe drawer 1 and safe housing 2 disclosed above, the system further comprises a controller 14, which is in communication with a user device 3.

The user device 3 may have the form of a smartphone or a tablet computer, with application software that is adapted for providing an interface for the drawer safe 1, 2. Hence, the user device may comprise a processing device, a communication device, a memory and a user interface. The user interface may be a touchscreen type user interface.

In one embodiment, the controller 14 is arranged to communicate with the user device 3 via short range communication, in particular short range radio communication, such as Bluetooth®, NFC, Wi-Fi or any similar short range radio communication standard.

Alternatively, or as a supplement, the controller 14 may be arranged to communicate with the user device 3 via another channel 4, such as via an internet connection, optionally via a remote server 6.

As yet another supplement, a tag 5 may be provided for identification of the drawer safe 1, 2. The tag may be any type of machine readable identification device, such as a barcode tag, a QR tag or an RFID tag.

In particular, a unique indentifier, which may be machine readable, such as a QR code, an RFID type tag or a barcode, may be associated with each safe. The identifier may be used for initializing an associating between a particular safe and a user account.

Hence, when setting up a safe for the first time, the user may download an app to his/her user device, cause the user device to read the identifier and set up a user account associating the particular safe with the user account and optionally with the particular user device. Once such an association has been set up, access to the safe may be provided in different ways, including:

the controller sensing the proximity of the user device,

the controller receiving a control signal from the user device, whereby the control signal may be generated based on entry of e.g. a pin code or biometric data into the user device, or

input of biometric data to a biometric reader arranged on the cabinet in which the safe is installed or on the safe itself.

In one embodiment, the user device 3 may connect with the drawer safe 1, 2 controller 14 via the short range communication. This short range communication may provide identification of the drawer safe 1, 2 to the user device 3 and identification of the user device 3 to the controller 14 of the drawer safe 1, 3.

Alternatively, the drawer safe 1, 2 may be identified by the user device through reading of the tag 5. Hence, the inputting of an unlock command may be enabled only when the tag has been read, and optionally only within a certain time of the tag having been read. In this embodiment, communication between the user device 3 and the controller 14 may be through short range communication, as in the previous embodiment, or through long range communication, such as via internet, via the remote server 6, etc.

Hence, when the user device 3 is in communication with the controller 14, the application software in the user device 3 may enable the user to input an unlock command.

When the user inputs an unlock command, the user device 3 may request authentication of the user, such as by a PIN code, a biometric reader, or the like.

When a user is authenticated, the user device 3 may send an unlock command to the controller 14 of the drawer safe 1, 2. Upon receipt of the unlock command, the controller 14 may provide a control signal to the actuator 13 to bring about unlocking of the drawer safe 1, 2, such that the user can pull out the drawer and access the contents of the drawer safe 1, 2.

In the case where the drawer safe also contains an inner drawer 100, as illustrated in FIGS. 3a-3d, the controller may also control the second actuator 15 to cause the lifting device 16 to lift the inner drawer 100.

Locking of the drawer safe 1, 2 may be achieved by the user inputting a lock command into the user device 3, which then sends a lock command to the controller 14.

The drawer safe 1, 2 may comprise a first position sensor 110 for detecting a position of the locking device 11a, 11b. A status of the locking device may be communicated by the controller to the user device 3. Hence, the user device may indicate whether the drawer safe is currently locked or unlocked.

The drawer safe may further comprise a second position sensor 120 for detecting a position of the safe drawer 1. A status of the safe drawer 1 may be communicated by the controller 14 to the user device 3. Hence, the user device may only allow input of a lock command into the user device when the safe drawer 1 is in a fully retracted position.

The drawer safe may further comprise a third position sensor 130 for detecting a position of the lifting device 16.

Hence, based on information from the second position sensor, the controller 14 may be configured to only allow operation of the lifting device 16 to lift or to lower the inner drawer 100 when the safe drawer 1 is in a fully extended position.

A status of the lifting device 16 may be communicated by the controller 14 to the user device 3. Hence, the user device may only allow input of a lock command into the user device when the lifting device 16 is in a fully lowered position.

The status indications referred to above may be communicated to the user device 3 via the short range communication link or via the long range communication link (internet 4).

Optionally, status indications may be logged and saved to a user account by the remote server 6.

Yet optionally, the drawer safe 1, 2 may be controlled via the remote server, e.g. by means of a remote computer (not shown).

Optionally, automatic locking may be provided, if the status of the drawer is closed and the user have not locked it through the user device, after a predetermined amount of time, which may be configured by the user.

As an option, the movement of the safe drawer 1 may be achieved by means of a third actuator (not shown). Such third actuator may be controlled by the controller 14.

Based on information from the sensors, it is possible to limit operation of the third actuator based on the position of the locking members 11a, 11b and based on the position of the inner drawer 100, if any, such that the drawer can only be extended or retracted when the locking member 11a, 11b is in a retracted position and when the inner drawer 100 is in a retracted position.

The function of alternatingly locking the safe drawer to the safe housing or to the drawer can be achieved in other ways than with a slidable locking member. For example, a rotatable plate, which may be generally circular, may be provided with a cut-away segment at its periphery, so that the cut-away segment, by rotation of the disc, may be selectively oriented towards the safe housing or towards the drawer.

Further sensors may be provided, e.g. to sense position, movement, vibration, humidity, temperature or the like for the safe. Information from such sensors may be communicated to the user device.

Also unsuccessful attempts at accessing the safe may be recorded and optionally communicated to the user device.

It is also possible to provide communication between the safe and an alarm system such that an alarm may be provided in the event of an attempt to access the safe by an unauthorized person, or in the event of an attempt to move the safe.

As a supplement, a biometric reader device 7 may be positioned on an outwardly exposed surface of the cabinet and/or drawer in which the safe housing and the safe drawer are located. The biometric reader device 7 may be in communication with the controller 14.

The biometric reader device 7 may comprise a fingerprint reader and/or a camera configured for recognizing biometric features of a user. For example, the camera may be configured for recognizing features of a user's face or eye.

The biometric recognition may be performed by the controller 14, which may be configured to store, in a memory 141 associated with the controller 14, authorization data, which may indicate which user(s) is/are authorized to access the storage device.

A procedure for storing authorization data in the memory 141 may be controlled by the user device 3.

For example, a user may initiate an authorization setup procedure in the user device 3, whereby the controller 14 receives data from the biometric reader device 7 and stores such data in the memory 141 as indicating an authorized user.

An authorized user may access the storage device 1, 2 by interacting with the biometric reader device 7.

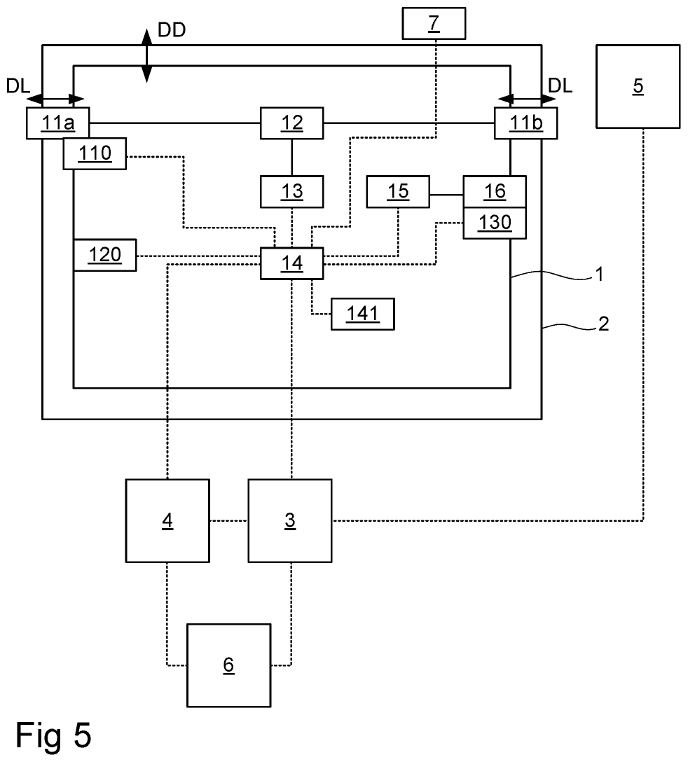

Referring to FIG. 6, there is illustrated another way of installing a safe in a chest of drawers. The chest of drawers comprises a cabinet 01 having, by way of illustration, at least two drawer spaces S1, S2.

In a first one S1 of the drawer spaces a first drawer 31 is installed. The drawer 31 s connected to the cabinet 01 by a slide bearing 32. The slide bearing may be any type of slide bearing, such as a shoulder on which the drawer rests, a groove in which a complementary groove or a shoulder arranged on the drawer is slidable, or a bearing mechanism, which may be formed from a different material than the cabinet 01 or the drawer 31. Such a bearing mechanism may comprise ball bearings, telescoping members, shock absorbers, etc.

The drawer 31 may be provided with a drawer front 33, which may be decorative and which may be visually matched with the cabinet.

In a second one S2 of the drawer spaces, there is installed a safe drawer 1 in its safe housing 2. The safe drawer 1 is slidably received in the safe housing 2. A slide bearing 18 may be installed in the safe housing 2 for interaction with the safe drawer 1, so as to facilitate a sliding motion between the safe housing and the safe drawer.

The safe drawer 1 and safe housing 2 may be designed in accordance with what has been described above.

A second drawer front 34 is connected at the safe drawer front 172.

Hence, compared with the first drawer 31, the safe drawer 1 with the safe housing 2 replaces the slide bearing 32, while being hidden by the second drawer front 34, such that the safe installation may be hidden inside the cabinet 01.

It is understood that a chest of drawers may be provided comprising a plurality of drawers, wherein drawer bodies and slide bearing of one or more drawers is/are replaced by a safe drawer/safe housing arrangement.

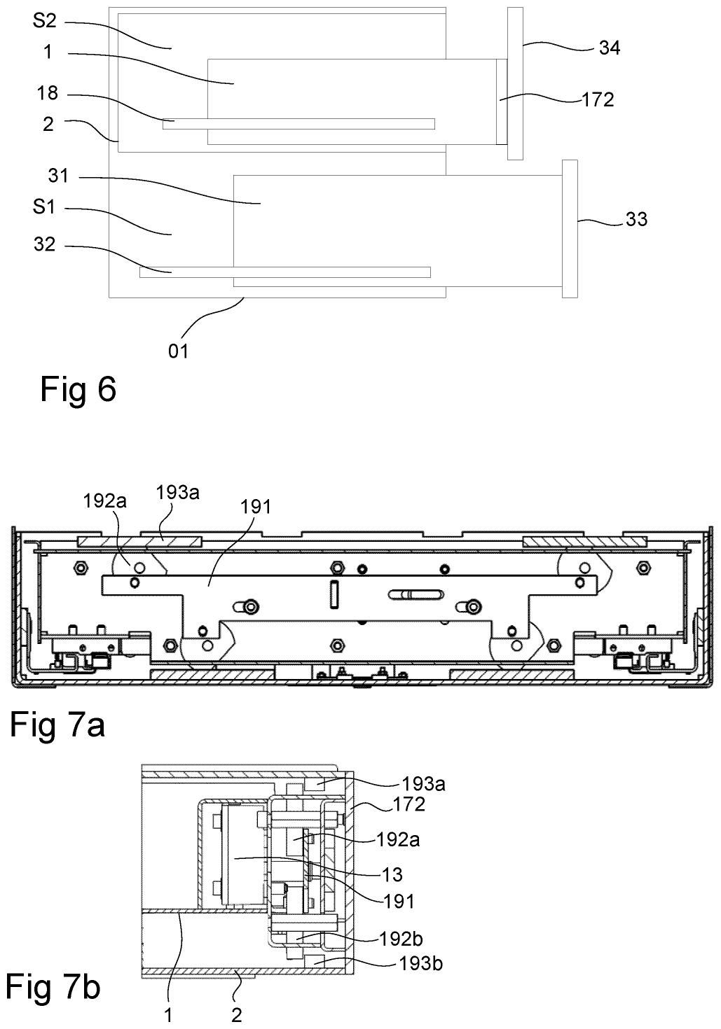

Referring to FIGS. 7a-7b, there is illustrated a locking mechanism, which may be used instead of the locking mechanism disclosed in FIGS. 4a-4c in embodiments where the safe drawer is to be selectively lockable to the safe housing, but not connectable to the cabinet drawer.

The locking mechanism illustrated in FIGS. 7a-7b is based on the use of one or more rotatable locking members 192a, 192b, each of which having a non-circular outline. In the illustrated example, the outlines are essentially circular with a cut-away segment. However, it is understood that other shapes, such as oval or polygonal may be used for the same purpose. The locking members 192a, 192b are rotatably mounted about a respective rotational axis.

Each of the locking members is arranged to selectively engage a locking shoulder 193a, 193b. Each locking shoulder may be provided as a piece of material that is mounted to the safe housing or as a groove in the safe housing.

In the illustrated example, there are four locking members. However, it is understood that, depending on requirements, at least one locking member may be sufficient.

A transmission mechanism may be provided by a sliding member 191, which may be eccentrically mounted to each of the locking members 192a, 192b, such that sliding of the sliding member cause the locking members 192a, 192b to rotate about their respective rotational axis.

An actuator 13 may be arranged to control a position of the sliding member 191.

The actuator 13 may be controllable as has been described with respect to FIGS. 1-5 above.

As will be appreciated, the safe, comprising the safe drawer and the safe housing, may be mounted to a cabinet in essentially two different ways.

In a first option, the safe housing is mounted in a drawer space belonging to a cabinet drawer that is slidably connected to the cabinet, whereby the safe housing is mounted above side walls of the cabinet drawer. Hence, the safe housing and the safe drawer will be hidden by a drawer front of the cabinet drawer and will effectively limit a load height of that cabinet drawer. The safe drawer may be operable independently of the cabinet drawer. Hence, the cabinet drawer may need to be opened before the safe drawer can be accessed.

Alternatively, the safe drawer may be selectively connectable to the cabinet drawer, such that, when the safe drawer is unlocked, it will connect to the cabinet drawer and thus become opened when the cabinet drawer is drawn out, i.e. it will follow the position of the cabinet drawer.

In a second option, the safe, comprising the safe drawer and the safe housing, may essentially replace the drawer body and the bearing mechanism of a drawer forming part of a chest of drawers. In this case, a drawer front may be mounted directly to a front portion of the safe drawer. The description above relating to the control system for controlling the actuator may be the same, regardless of the mechanical design of the safe drawer, its mounting in the cabinet and the locking mechanism.

1-59. (canceled)

60. A storage device for theft-proof storage of valuable articles, comprising:
a cabinet, having at least one drawer space,
a safe drawer, which is received in the drawer space,
a safe housing, comprising side walls and a top wall connecting the side walls, wherein the safe drawer is slidably connected to the safe housing and wherein the safe housing is mounted to the cabinet in the drawer space,
a locking member, which is movably connected to the safe drawer or to the safe housing,
an actuator, which is operatively connected to the locking member, for controlling a movement of the locking member, and
a controller, which is operatively connected to the actuator, and which is configured to control the actuator,
wherein the controller is configured for receiving a control signal, based on which the controller is configured to control the actuator,
wherein the locking member is movable between a first position, in which the locking member locks safe drawer relative to the cabinet, and a second position, wherein the safe drawer is unlocked relative to the cabinet, and
wherein the safe drawer is received in the drawer space in a drawer space portion that is situated at least partially, preferably entirely, above side walls of a drawer, which is slidably mounted to the cabinet and received in said drawer space.

61. The device as claimed in claim 60, further comprising an anchoring device, which connects the safe housing to a fixed structure, such as a wall or a fixed cabinet.

62. The device as claimed in claim 61, wherein the anchoring device comprises at least one connector which is connectable to the fixed structure from an inside of the safe housing.

63. The device as claimed in claim 61, wherein the anchoring device further comprises an anchoring plate which is mountable to the fixed structure, wherein connector is connectable to the anchoring plate.

64. The device as claimed in claim 60, further comprising a drawer coupling, which is configured to engage the drawer when the safe drawer is unlocked relative to the cabinet, such that the safe drawer is slidable with the drawer.

65. The device as claimed in claim 64, wherein the locking member has a first portion for engaging the safe housing and a second portion for engaging the drawer.

66. The device as claimed in claim 60, further comprising a locking arrangement, which is fixedly connected to the other one of the safe drawer and the safe housing, and which is adapted for engagement with the locking member, when the locking member is in said first position.

67. The device as claimed in claim 60, further comprising a transmission mechanism, which is operable between the actuator and the locking member, for controlling a position of the locking member.

68. The device as claimed in claim 60, further comprising a second locking member, said second locking member being spaced from the first locking member, so as to engage an opposite portion of the cabinet or of the safe housing.

69. The device as claimed in claim 60, wherein the safe drawer comprises a bottom, a pair of side walls, a front wall and a rear wall.

70. The device as claimed in claim 69, wherein said safe drawer side walls present a height, which corresponds to a maximum load height of a space in which the drawer is arranged, less a gap sufficient to enable movement of the safe drawer in the drawer space.

71. The device as claimed in claim 60, wherein said safe housing presents a height, which corresponds to a maximum load height of a space in which the drawer is arranged.

72. The device as claimed in claim 69, wherein the safe drawer bottom, side walls, front wall and rear wall are formed of sheet metal, having a thickness of at least 1.5 mm, preferably at least 2.5 mm or at least 4 mm and most preferably a thickness of 6-10 mm.

73. The device as claimed in claim 60, wherein the controller comprises a wireless communication device for receiving said signal in the form of a control signal.

74. A system for theft-proof storage of valuable articles, comprising:
at least one storage device as claimed in claim 60, and
a user device in the form of a tablet computer or a smartphone, wherein the user device is configured to communicate with the controller.

75. The system as claimed in claim 74, wherein the user device is configured to generate or receive a signal representing a storage device ID, when the user device is in proximity of the storage device.

76. The system as claimed in claim 74, wherein the user device is configured to read an identification tag arranged on or near the cabinet.

77. The system as claimed in claim 74, wherein the user device is configured to establish a short range communication link with the controller.

78. The system as claimed in claim 74, wherein the user device is configured to identify a user who is authorized to operate the storage device, and to send a signal to the controller, causing the controller to unlock the safe drawer unlocked relative to the cabinet, when an authorized user is identified.

79. The system as claimed in claim 74, wherein the controller is configured to send a status signal to the user device, indicating at least one of: a position of the locking member, a position of the safe drawer and a position of the lifting mechanism, if any.
